(19) United States
(12) Patent Application Publication
(10) Pub. No.: US 2014/0111860 A1
(43) Pub. Date: Apr. 24, 2014

(54) MIRROR JACKET

(71) Applicant: Barbara Bordewisch Beam, Kettering, OH (US)

(72) Inventor: Barbara Bordewisch Beam, Kettering, OH (US)

(21) Appl. No.: 13/659,896

(22) Filed: Oct. 24, 2012

(51) Int. Cl. B60J 11/06

(52) U.S. Cl. 359/507

(57) ABSTRACT

A mirror jacket for protecting a side view mirror having a shell with a support member attached to a motor vehicle and an adjustable mirror carried within an open end of the shell facing the rear of the motor vehicle. The mirror jacket comprises a pouch having a sleeve formed about an open end. The pouch is sized to slip over and cover the shell and adjustable mirror of the side view mirror. A drawstring exits through the sleeve of the pouch. When the drawstring is pulled tightly closed about the support member of the side view mirror, moisture, frost, snow, ice and dirt will not make contact with the adjustable mirror of the side view mirror.

### CROSS-REFERENCE TO RELATED APPLICATION

This application claims the benefit of Provisional Patent Application No. 61/550,590, filed on Oct. 24, 2011, in the United States Patent & Trademark Office, the disclosure of which is incorporated herein by reference.

### BACKGROUND OF THE INVENTION

1. Field of the Invention

The present invention relates to a mirror cover, and more particularly, a mirror jacket.

In inclement weather, adjustable mirrors of side view mirrors on parked motor vehicles can become covered with moisture, ice, snow, frost or dirt. Drivers have to spend extra time before they leave when cleaning off the adjustable mirrors. If the adjustable mirrors are not completely clear before operating the motor vehicles, motorists risk serious injury or even death by driving with impaired visibility. While cleaning off the adjustable mirrors positions can be accidentally shifted and unintentional scraping can damage the adjustable mirrors. Both fuel and time are wasted waiting for the adjustable mirrors to clear up. Motorists need a safe and easy way to protect both their motor vehicles and visibility in inclement weather conditions.

The mirror jacket protects the side view mirror on a motor vehicle from environmental elements that can damage the glass of the adjustable mirror and impair driver visibility. The present invention encases the side view mirror for protection while not in use, allowing the driver immediate and clear visibility when they need it, even in the worst conditions. The mirror jacket prevents the driver from having to scrape off the adjustable mirror, risking scratches or wait with the engine of motor vehicle running while the adjustable mirror clears up, wasting gas. Anyone who will ever drive in inclement weather conditions will appreciate the protection that the present invention provides.

2. Description of the Prior Art

Numerous innovations for side view mirror covers have been provided in the prior art that will be described. Even though these innovations may be suitable for the specific individual purposes to which they address, however, they differ from the present invention.

A FIRST EXAMPLE, U.S. Pat. No. 4,834,157, Issued on May 30, 1989, to Smith teaches a cover assembly designed specifically to removably cover and thereby protect the exterior exposed surface of a housing or support for an exteriorly mounted mirror on an automobile or like vehicle commonly known as rear-view mirrors or side mirrors thereby protecting the finish of the exposed surface of the mirror mount from blemishes, stains, scratches, and generally the harsh environment to which such surface is subjected during the normal travel of a vehicle without detracting from the appearance of the mirror mount or the vehicle itself.

A SECOND EXAMPLE, U.S. Pat. No. 6,325,121, Issued on Dec. 4, 2001, to Hundnall teaches a side view mirror cover. The mirror cover includes a bonnet-like cover portion designed to conform to the exterior shape of the side view mirror housing. An elastic gather is provided along the open rear of the cover. A first pair of securement straps are provided for bringing together the ends of the elastic gather. A separate securement is provided for the open base of the cover about the stem attaching the mirror housing to the vehicle.

A THIRD EXAMPLE, U.S. Patent Office Publication No. 2004/0238088, Published on Dec. 2, 2004, to D'Andrea teaches an apparatus for protecting an exteriorly mounted mirror. The apparatus contains a first portion having an interior portion and an exterior portion, and a second portion having an interior portion and an exterior portion, wherein a portion of the first portion and the second portion is attached to define an inner volume within the apparatus, and wherein an opening is defined by a portion of the first portion and the second portion that is not attached. A first connecting means is attached to the exterior portion of the first portion and a second connecting means is attached to the exterior portion of the second portion, wherein fastening the first connecting means and the second connecting means decreases a size of the opening.

A FOURTH EXAMPLE, U.S. Pat. No. D633,430, Issued on Mar. 1, 2011, to Stephanis et al. teaches an ornamental design for a side mirror cover with strap, as shown and described.

A FIFTH EXAMPLE, U.S. Patent Office Publication No. 2012/0154911, Published on Jun. 21, 2012, to Huynh et al. teaches a cover for a side view mirror of a car having a shell attached to the car where the shell has a closed side facing the front of the car, an open end facing the rear of the car and a movable mirror located in the open end of the shell. The cover, which may be a blend of material, covers the closed side of the shell and may have a display printed thereon visible from the front of the car. An elastic draw string is located in a channel of the cover or Velcro strips are located on the inside surface of the cover. The cover is attached to the side view mirror by placing the ends of the channel around the side view mirror and fastening the ends of the elastic draw string together after pulling them tight or engaging Velcro strips located on the shell.

It is apparent now that numerous innovations for side view mirror covers have been provided in the prior art that are adequate for various purposes. Furthermore, even though these innovations may be suitable for the specific individual purposes to which they address, accordingly, they would not be suitable for the purposes of the present invention as heretofore described.

### SUMMARY OF THE INVENTION

AN OBJECT of the present invention is to provide a mirror jacket that avoids the disadvantages of the prior art.

ANOTHER OBJECT of the present invention is to provide a mirror jacket that is simple and inexpensive to manufacture.

STILL ANOTHER OBJECT of the present invention is to provide a mirror jacket that is simple to use.

BRIEFLY STATED, STILL YET ANOTHER OBJECT of the present invention is to provide a mirror jacket for protecting a side view mirror having a shell with a support member attached to a motor vehicle and an adjustable mirror carried within an open end of the shell facing the rear of the motor vehicle. The mirror jacket comprises a pouch having a sleeve formed about an open end. The pouch is sized to slip over and cover the shell and adjustable mirror of the side view mirror. A drawstring exits through the sleeve of the pouch. When the drawstring is pulled tightly closed about the support member of the side view mirror, moisture, frost, snow, ice and dirt will not make contact with the adjustable mirror of the side view mirror.

The novel features which are considered characteristic of the present invention are set forth in the appended claims. The invention itself, however, both as to its construction and its method of operation, together with additional objects and advantages thereof, will be best understood from the following description of the specific embodiments when read and understood in connection with the accompanying drawing.

### BRIEF DESCRIPTION OF THE DRAWING

The figures of the drawings are briefly described as follows:

FIG. 1 is a perspective view showing the present invention being installed over a side view mirror of a motor vehicle;

FIG. 2 is a perspective view showing the drawstring of the present invention being pulled tight and secured at the support member of the side view mirror;

FIGS. 3 to 5 are perspective views showing various angles of the drawstring construction; and

FIG. 6 is a perspective view of a spring-loaded slide member.

### REFERENCE NUMERALS UTILIZED IN THE DRAWING

110 mirror jacket
112 side view mirror
114 shell of side view mirror 112
116 support member of side view mirror 112
118 motor vehicle
120 adjustable mirror of side view mirror 112
122 pouch of mirror jacket 110
124 sleeve on pouch 122
126 open end of pouch 122
128 drawstring of mirror jacket 110
130 interior soft cloth sheet of pouch 122
132 flannel for interior soft cloth sheet 130
134 exterior waterproof sheet of pouch 122
136 plastic for exterior waterproof sheet 134
138 elongated lace for drawstring 128
140 slide member of drawstring 128
142 aperture in slide member 140
144 metal spring for plastic plunger 146
146 plastic plunger
148 lower body of the plastic plunger 146
150 aperture in the lower body 148 of the plastic plunger 146

### DETAILED DESCRIPTION OF THE PREFERRED EMBODIMENT

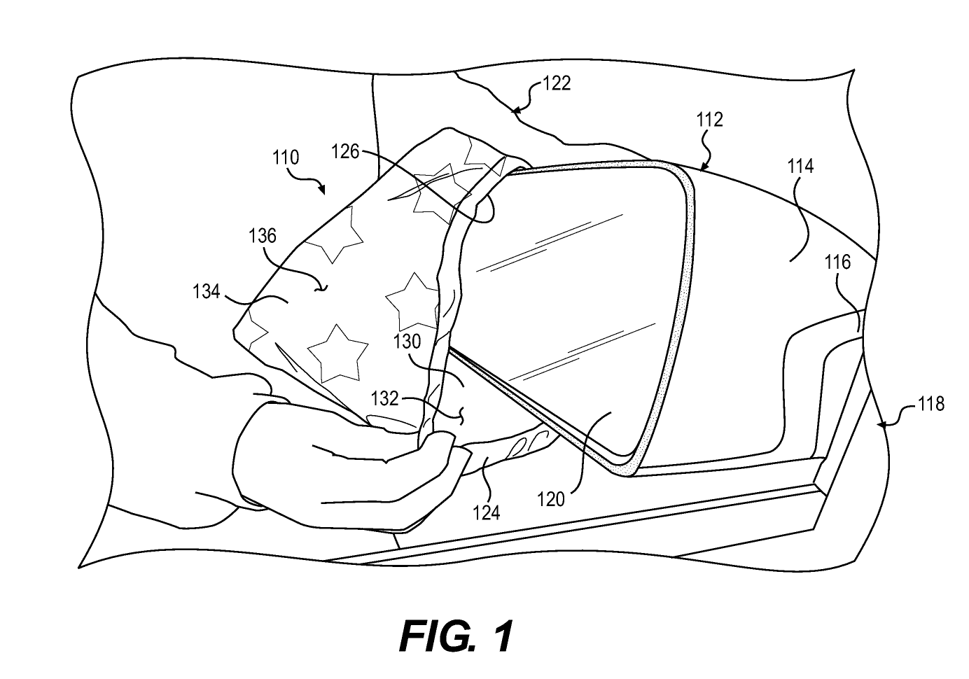

As shown in FIG. 1, the present invention is a mirror jacket 110 for protecting a side view mirror 112 having a shell 114 with a support member 116 attached to a motor vehicle 118 and an adjustable mirror 120 carried within an open end of the shell 114 facing the rear of the motor vehicle 118. The mirror jacket 110 comprises a pouch 122 having a sleeve 124 formed about an open end 126. The pouch 122 is sized to slip over and cover the shell 114 and adjustable mirror 120 of the side view mirror 112.

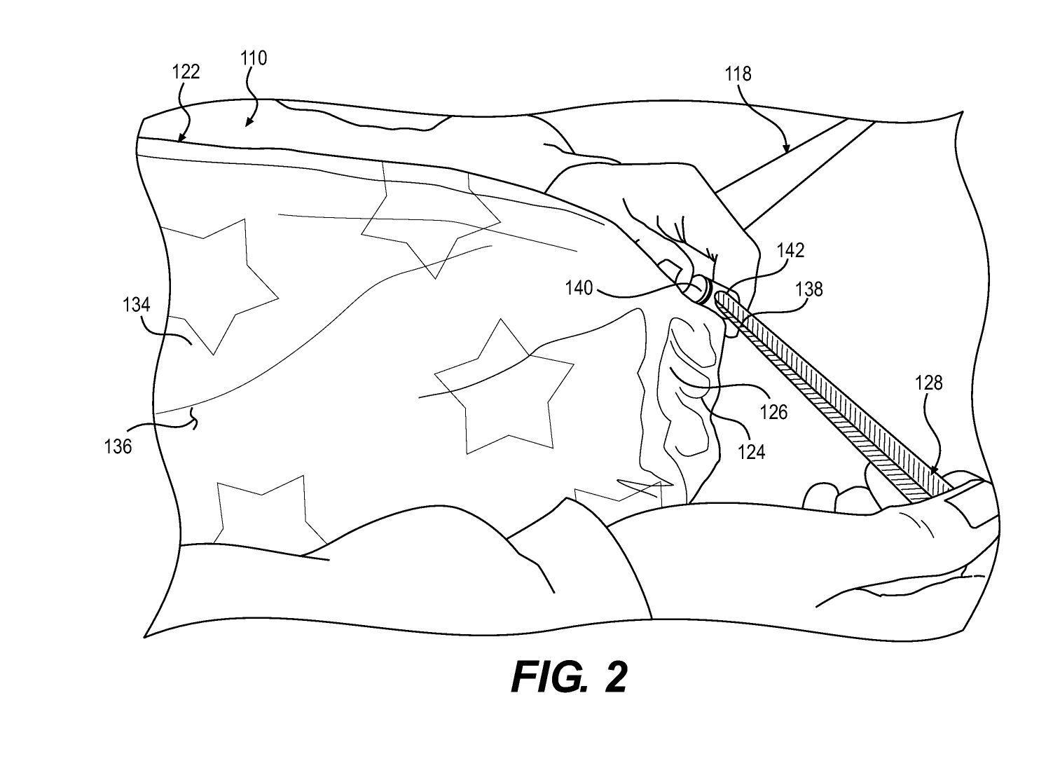

As shown in FIG. 2, a drawstring 128 exits through the sleeve 124 of the pouch 122. When the drawstring 128 is pulled tightly closed about the support member 116 of the side view mirror 112, moisture, frost, snow, ice and dirt will not make contact with the adjustable mirror 120 of the side view mirror 112.

The pouch 122 is comprised of an interior soft cloth sheet 130 to prevent scratching the adjustable mirror 120 of the side view mirror 122. The interior soft cloth sheet 130 consists of flannel 132. The pouch 122 is also comprised of an exterior waterproof sheet 134 to prevent the moisture, frost, snow, ice and dirt from reaching the adjustable mirror 120 of the side view mirror 112. The exterior waterproof sheet 134 is comprised of plastic 136.

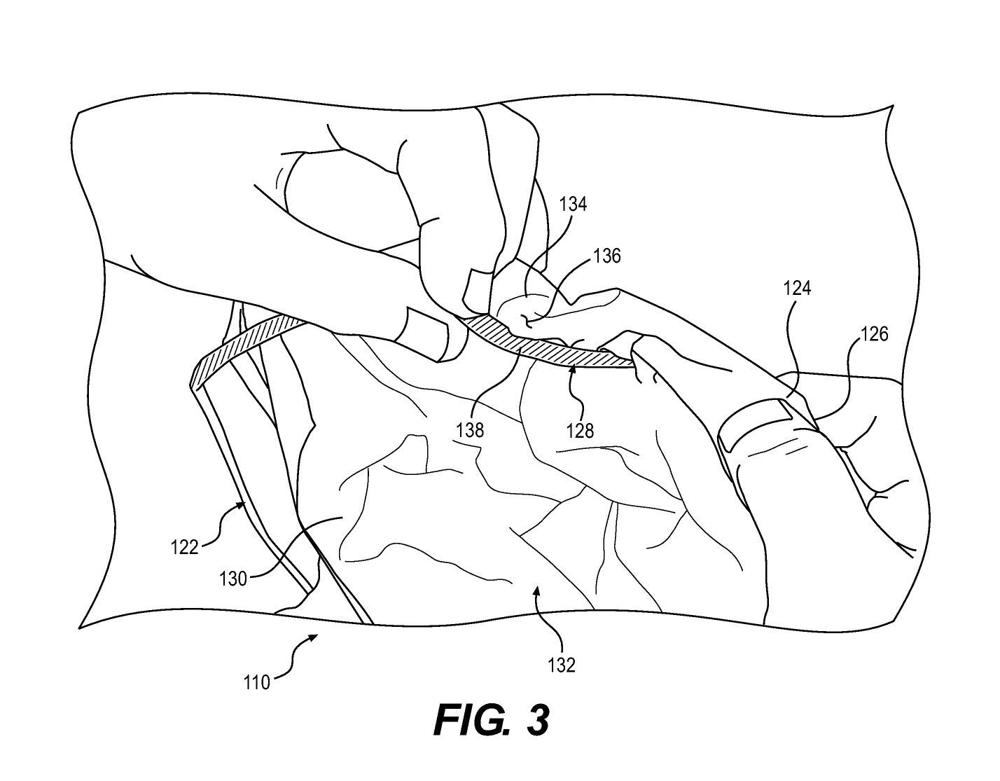

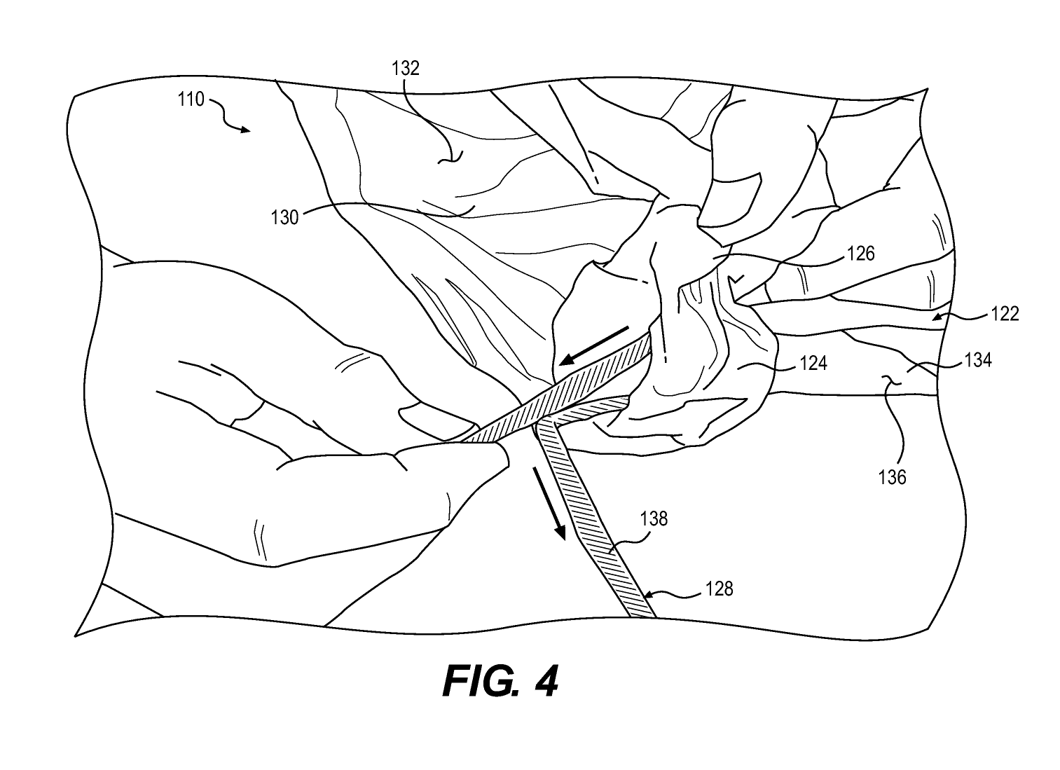

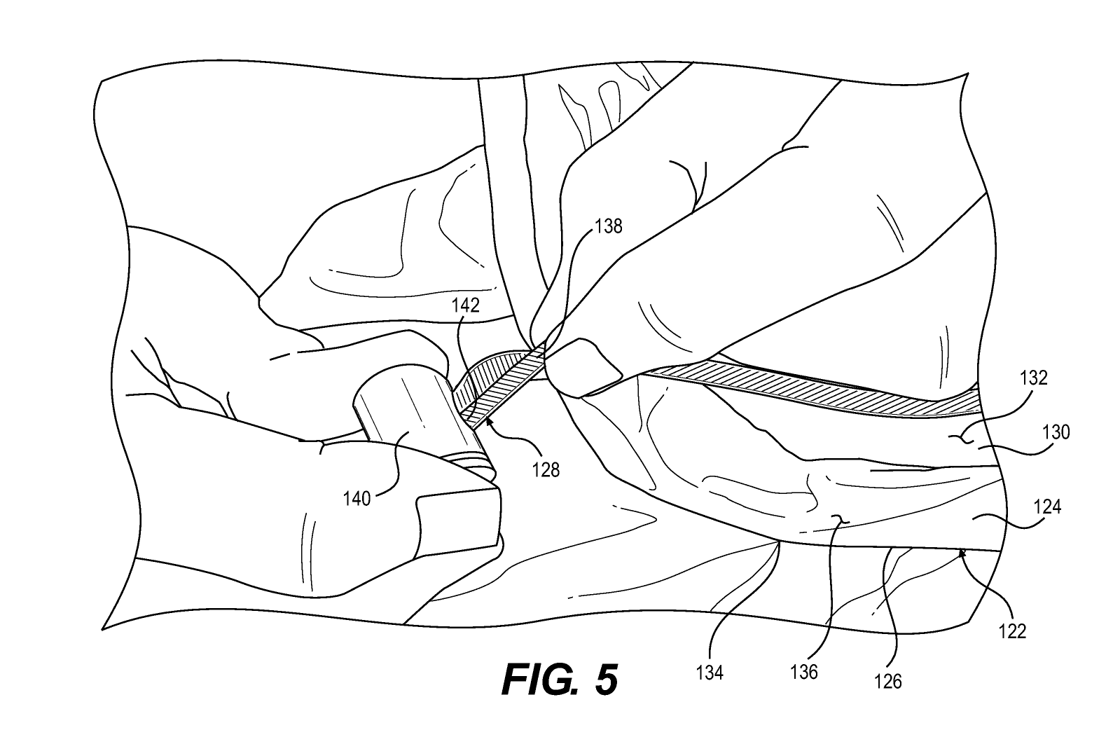

As shown in FIGS. 3, 4 and 5, the drawstring 128 consists of an elongated lace 138. The drawstring 128 further contains a slide member 140 having an aperture 142 to allow free ends of the elongated lace 138 to pass through the aperture 142 to tighten the elongated lace 138 against the support member 116 of the side view mirror 112 and collapse the open end 126 of the pouch 122 thereto.

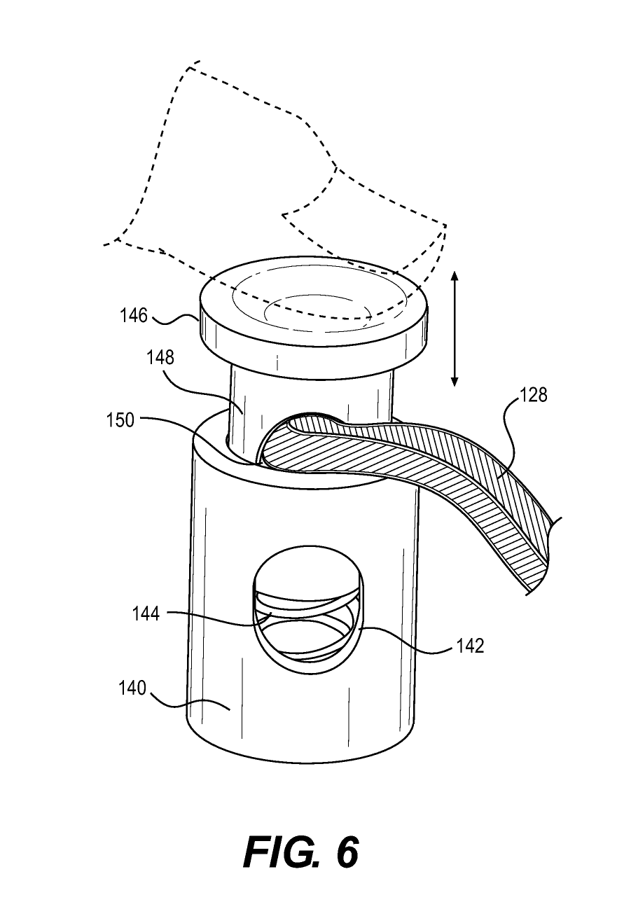

As shown in FIG. 6, the slide member 140 has an outer sleeve with an aperture 142, and a plastic plunger 146 with a lower body 148. The lower body 148 has another aperture 150. The lower body 148 is pushed up by a metal spring 144. The user pushed the plastic plunger 146 down until both apertures 142 and 150 are aligned. Then, the drawstring 128 can be passed both apertures 142, and 150 easily. When the plastic plunger 146 is released, then the plunger 146 is pushed up by the metal spring 144. Therefore, the plunger 146 locked the drawstring 128. The slide member 140 has 0.25 inch in diameter, and 0.75 inch in total height.

In summary the mirror jacket 110 is an all weather cover for the side view mirror 112 to keep the adjustable mirror 120 within the shell 114 clear of visual impairments like moisture, frost, snow, ice and dirt. The present invention being the pouch 122 is made of approximately two thirds of a yard of material folded and stitched in half forming the sleeve 124 at the open end 126, with the drawstring 128 enclosure. The pouch 122 can be slipped over the side view mirror 112 and the drawstring 128 can be pulled tightly closed against the support member 116 of the side view mirror 112, to prevent cold and moisture from contacting the adjustable mirror 120. The drawstring 128 being the elongated lace 138 can then be closed securely by the slide member 140 having the aperture 142 to keep the present invention in place. The exterior waterproof sheet 134 is made of any suitable material, such as plastic 136 and the interior soft cloth sheet 130 is made of flannel 132 or any other appropriate material that will avoid scratching the adjustable mirror 120. When not in use, the present invention can be easily and compactly stored inside the motor vehicle 118. Approximate dimensions may be eleven inches by eleven inches by six and a half inches (11″×11″×6.5″ inches), but exact specifications may vary.

It will be understood that each of the elements described above, or two or more together, may also find a useful application in other types of constructions differing from the types described above.

While the invention has been illustrated and described as embodiments of a mirror jacket, accordingly it is not limited to the details shown, since it will be understood that various omissions, modifications, substitutions and changes in the forms and details of the device illustrated and its operation can be made by those skilled in the art without departing in any way from the spirit of the present invention.

Without further analysis, the foregoing will so fully reveal the gist of the present invention that others can, by applying current knowledge, readily adapt it for various applications without omitting features that, from the standpoint of prior art, fairly constitute characteristics of the generic or specific aspects of this invention.

The invention claimed is:

1. A mirror jacket for protecting a side view mirror having a shell with a support member attached to a motor vehicle and an adjustable mirror carried within an open end of the shell facing the rear of the motor vehicle, the mirror jacket comprising:
a) a pouch having a sleeve formed about an open end, the pouch sized to slip over and cover the shell and adjustable mirror of the side view mirror; and
b) a drawstring exiting through the sleeve of the pouch, whereby when the drawstring is pulled tightly closed about the support member of the side view mirror, moisture, frost, snow, ice and dirt will not make contact with the adjustable mirror of the side view mirror.

2. The mirror jacket as recited in claim 1, wherein the pouch comprises an interior soft cloth sheet to prevent scratching the adjustable mirror of the side view mirror.

3. The mirror jacket as recited in claim 2, wherein the interior soft cloth sheet is comprised of flannel.

4. The mirror jacket as recited in claim 1, wherein the pouch comprises an exterior waterproof sheet to prevent the moisture, frost, snow, ice and dirt from reaching the adjustable mirror of the side view mirror.

5. The mirror jacket as recited in claim 4, wherein the exterior waterproof sheet is comprised of plastic.

6. The mirror jacket as recited in claim 1, wherein the drawstring is comprised of an elongated lace.

7. The mirror jacket as recited in claim 6, wherein the drawstring further comprises a slide member having an aperture to allow free ends of the elongated lace to pass through the aperture to tighten the elongated lace against the support member of the side view mirror and collapse the open end of the pouch thereto.

8. The mirror jacket as recited in claim 7, wherein the slide member further include an outer sleeve with an aperture 142, and a plastic plunger 146 with a lower body 148.

9. The mirror jacket as recited in claim 8, wherein the lower body has another aperture and the lower body is pushed up by a metal spring.

10. The mirror jacket as recited in claim 9, wherein the drawstring can be passed both apertures easily during plunger pushing down and the drawstring can be locked in position when the plastic plunger is released and the plunger is pushed up by the metal spring.

11. The mirror jacket as recited in claim 7, wherein the slide member 140 has 0.25 inch in diameter, and 0.75 inch in total height.

12. The mirror jacket as recited in claim 1, wherein the Jacket having dimensions eleven inches by eleven inches by six and a half inches (11″×11″×6.5″ inches).
